(19) United States
(12) Patent Application Publication
(10) Pub. No.: US 2007/0060463 A1
(43) Pub. Date: Mar. 15, 2007

(54) METHOD FOR PRODUCING METALLIC AND CERAMIC HOLLOW BODIES

(75) Inventor: UDO GAUMANN, Aschaffenburg (DE)

Correspondence Address: Ursula B. Day;Henry M. Feiereisen, LLC, Suite 4714, 350 Fifth Avenue, New York, NY, 10118, US

(73) Assignees: Udo Gaumann, Aschaffenburg (DE); Ralf Schacher, Munderkingen (DE)

(21) Appl. No.: 11/533,057

(22) Filed: Sep. 19, 2006

Related U.S. Application Data
(63) Continuation-in-part of application No. PCT/EP05/02885, filed on Mar. 17, 2005.

(30) Foreign Application Priority Data
Mar. 19, 2004 (DE) 10 2004 014 017.0

(51) Int. Cl. C04B 35/00; B29C 41/08; C04B 35/64

(52) U.S. Cl. 501/1; 264/632; 264/636; 264/309

(57) ABSTRACT

The invention relates to a method for producing a hollow body comprising at least one metallic or ceramic component, wherein a binder is mixed with a ceramic and/or metallic powder and the viscosity is set to a value in excess of 1000 Pa-s and the mixture then formed into a tube by means of one or more dies, wherein the so formed tube is then formed into a green compact by means of a blow molding process and subsequnetly converted into a brown compact by removal of the binder, wherein said brown compact is in turn converted into a finished hollow body through a thermal treatment step.

### CROSS-REFERENCE TO RELATED APPLICATIONS

This application is a continuation-in-part of PCT Application No. PCT/EP2005/002885, filed Mar. 17, 2005, incorporated herein by reference, which claims the priority of German Patent Application No. 10 2004 014 017, filed on Mar. 19, 2004.

### BACKGROUND OF THE INVENTION

1. Field of the Invention

In the automotive industry, a large number of tubular lines are used in various shapes, for example for the supply of air to the engine or as a tank connection piece. A series of stringent technical requirements are placed on tubular lines of this type, which technical requirements are a result, in particular, of the rough environmental conditions, for example in the engine compartment.

2. Description of Related Art

Traditionally, tubular lines are manufactured from technical plastics, such as polyamide. However, said technical plastics frequently reach the limits of their applicability. In particular, the thermal dimensional stability of many technical plastics does not always meet the requirements which exist as a result of the high temperatures in the engine compartment. Many tubular lines in the engine compartment are therefore already shaped from metallic materials again nowadays.

A standard process for shaping metal pipes is the hydroforming process. In this process, a metal pipe is filled with a fluid (for example, oil) and is inserted into a mold with a mold nest. An excess pressure is generated in the fluid with the aid of plungers, as a result of which the metal pipe is deformed and is adapted to the external shape of the mold nest in the mold. However, the hydroforming process is complicated and expensive, and the geometries which can be achieved are limited.

### SUMMARY OF THE INVENTION

It is an object of the invention to specify an inexpensive method which makes it possible to manufacture complex hollow bodies from thermally resistant material. Here, as free a selection of the geometry of the hollow bodies as possible is to be possible. Furthermore, the use of different materials within one component is also to be possible.

This object is achieved by the inventions having the features of the independent claims. Advantageous developments of the inventions are characterized in the subclaims.

A method is proposed for manufacturing a hollow body which has at least one metallic and/or ceramic component. The method is to have the following steps (see FIG. 1):
a binder material is mixed with a ceramic and/or metallic powder (step 10 in FIG. 1),
the viscosity of the mixture is set to a value of at least 1000 Pa s (step 12),
the mixture which is produced is shaped into a tube by means of one or a plurality of nozzles (step 14),
the tube is shaped to form a second hollow body (green product) by means of a blow molding process (step 16),
the green product is converted into a third hollow body (brown product) with removal of the binder material (binder removal) (step 18),
the brown product is converted into the first hollow body by a temperature treatment step (sintering) (step 20), and
step c) being carried out in such a way that the tube which is produced has a macroscopically varying composition.

The method steps a), e) and f) have similarities with what is known as the “powder injection molding” (PIM) process which is known from injection molding technology. In this process, a green product is molded from a thermoplastic mixture of a binder material and a metallic or ceramic powder by means of a commercially available injection molding machine and a corresponding mold. After demolding, the binder material is removed from the green product by a first treatment at increased temperature, by different solvents or by catalytic treatment, as a result of which a brown product is produced. Subsequently, said brown product is sintered, with the result that a solid metallic or ceramic component is produced.

In accordance with the materials which are used, a distinction is made in the PIM process between “metal injection molding” (MIM) and “ceramic injection molding” (CIM). One example for the use of MIM for the manufacture of camera housings is described in JP 2001288501 A.

However, the use of the injection molding process in the form of a PIM process frequently causes insurmountable difficulties, in particular in components which have a hollow space. It is therefore also the case that the manufacture of metallic or ceramic hollow bodies according to the MIM or CIM process has not been possible up to now, or has been possible only with difficulty. JP 08143911 A describes a method, according to which an axial hollow space can be produced in an MIM or CIM component by means of a central mandrel in a mold. In this way, hollow bodies can therefore also be produced by injection molding, the selection of the geometry of the hollow bodies being severely restricted, however, as the central mandrel has to be removed from the component after injection molding.

The method according to the invention overcomes these problems by combining the principle of the PIM process with aspects of blow molding technology. A summary of the different known blow molding processes can be found, for example, in DuPont Technische Kunststoffe: Blasformanleitung [DuPont Technical Plastics: blow molding instructions].

During blow molding, a tube is inflated in a mold, until it has assumed the shape of the mold nest in the mold. However, it has been possible up to now to use the known blow molding processes only for certain technical plastics, but not for the mixtures which are used in the PIM process, as the viscosity is too low in these mixtures. A stable tube, as is required for the blow molding process, cannot therefore be produced with these mixtures. In the method according to the invention, the viscosity of the mixture is set to a value of at least 1000 Pa s, which makes it possible to manufacture a stable tube. The latter can then be processed by means of the blow molding process. In this way, complex metallic and/or ceramic hollow bodies can also be manufactured by the described method.

Here, in the context of this invention, a hollow body is to be understood as a component which has at least one closed hollow space. Irrespective of this, however, this hollow space can be opened by the following method steps (for example, by cutting or milling before method step e) or f)), with the result that, for example, an open pipe is produced.

The hollow body can consist entirely or partially of a metallic and/or ceramic material or be configured in such a way that different sections of the hollow body consist of different materials.

The individual method steps will be described in greater detail in the following text. The steps do not necessarily have to be carried out in the specified order, and the method can also have further steps which are not mentioned.

First of all, a binder material is mixed with a ceramic and/or metallic powder. This method step can be a constituent part of the method on site or, analogously, can also take place separately at a raw material supplier. Further fillers can also be added to the mixture in order to improve the mechanical properties and/or to set defined magnetic, electrical, thermal or optical properties.

In principle, a great number of metallic or ceramic powders of different grain sizes and grain shapes which can be sintered can be used. Metallic alloys, metal oxides, carbides or nitrides or organometallic aggregates and other compounds of metallic elements can also be used. Mixtures of metallic and ceramic powders are also possible, or mixtures of different metals or ceramic materials. Here, the grain size and grain shape substantially define the porosity of the later workpiece and the isotropy or anisotropy of the volumetric shrinkage during binder removal and sintering.

Both organic materials (for example, thermoplastics or waxes) and inorganic materials (for example, silicones) can be used as binder material.

It should be possible for the binder to be removed as completely as possible from the component during subsequent binder removal by thermal treatment and/or solvent treatment and/or by catalytic decomposition.

The mixing process can take place, for example, in a mixing assembly. Subsequent homogenization of the mixture and granulation can also be included analogously in this mixing process. The composition of a possible mixture will be described in more detail further below in the description.

The mixture is set to a viscosity of at least 1000 Pa s, preferably even to a viscosity of at least 3000 Pa s. Even viscosities of more than 10,000 Pa s or even of 40,000 Pa s and more are frequently used.

This very high viscosity compared with injection molding (see, for example, DE 199 25 197 A1) is necessary, in order to ensure the formation of a stable tube body. Depending on the type of materials which are used, the viscosity can be set in different ways. If thermoplastic binder materials are used, the viscosity can be set, in addition to a suitable selection of the thermoplastic materials, by temperature control to a defined temperature and/or by the effect of defined shear forces. This method step is typically carried out by means of suitable extruders which can be equipped, for example, with a heated nozzle. Here, the mixture is plasticized by means of an extruder worm, that is to say is set to the desired viscosity and is extruded to form the tube (method step c)).

As an alternative, the viscosity can also be set, for example, by the use of suitable thermosetting or elastomeric binder materials, for example by the addition of silicone-like materials.

The mixture which is produced is subsequently shaped into a tube by means of one or a plurality of nozzles. The method step of tube shaping can take place, for example, by means of an extruder. This extruder can be, for example, a commercially available extruder which extrudes a tube, for example, in the horizontal or vertical direction.

Here, this can be not only a radially symmetrical tube or a tube with a round cross-sectional geometry, but also, for example, a tube with a different cross-sectional geometry, for example with a polygonal or oval cross-sectional geometry. The cross-sectional geometry of the tube can also vary along a tube axis. An injection-molded, tube-like preformed product (as is formed, for example, during injection blow molding) is also possible.

The wall thickness of the tube can also correspondingly vary along the tube axis or in a plane which is perpendicular with respect to the tube axis. The latter is of advantage, for example, when components are to be manufactured which are of more pronounced curvature in different sections than in other sections. One important example is represented by pipes having a thread or a folding bellows. The tube material is subsequently stretched to a greater extent during inflation in the region of the thread than in other regions, with the result that an increase in the wall thickness of the tube in this region can lead to improved wall thickness homogeneity.

The tube is subsequently shaped into a second hollow body (green product) by means of a blow molding process. Here, all known blow molding processes can be used in principle.

In one possible form of the blow molding process, the plastic tube is first of all inserted into a mold with the aid of a gripper. Said mold has two complementary halves which each have complementary cavities (mold nests). One example for the manufacture of molds of this type is described in JP 60162623 A.

The mold is closed by means of a closing apparatus (which is, for example, hydraulic). In the closed state, the cavities complement one another to form a contiguous mold nest which is modeled on the external design of the hollow body which is to be shaped.

An excess pressure is produced in the interior of the plastic tube with the aid of a blow pin, as a result of which the plastic tube is inflated and its external shape is adapted to the shape of the mold nest in the mold. After cooling and solidification of the plastic, the mold can be opened and the finished workpiece can be removed (demolding).

In an alternative process (suck-blow molding), the plastic tube is not introduced into an open mold with the aid of a gripper, but is sucked into a closed mold through a suction opening by means of a vacuum. The suction opening is then closed by a slide, and the plastic tube is subsequently inflated, as described above.

In principle, a common feature of the different variants of the blow molding process is therefore that the tube (or preformed product) is inflated in a mold which has one or more cavities by an increase in the internal pressure in the tube, until the outer design of the tube has been adapted at least approximately to the shape of the cavity.

Inflation can take place, for example, by a blow pin which is connected at one end to a compressor (or a pump) and protrudes or is introduced at another end into the interior of the tube. The use of a plurality of blow pins is also possible. In order to build up the internal pressure in the tube, gases (for example, air or nitrogen) or else other fluids (for example, oils) can be introduced into the interior of the tube.

It has been shown that the mixtures which are suitable for blow molding of ceramic or metal hollow bodies frequently have a high crystallization temperature and therefore solidify rapidly. In order that the melt does not solidify before its external design has been adapted to the inner walls of the cavity, it is advantageous to operate the molds at an increased temperature. The wall temperatures which are typically used during blow molding of plastics of from 3° C. to 20° C. are therefore frequently unsuitable during blow molding of ceramic and/or metal mixtures. A wall temperature of from 60° C. to 120° C. has proven favorable, in particular, for mixtures of this type. For this purpose, a suitable heating circuit (for example, for temperature control with water, ethylene glycol or oil) can be integrated into the mold. In order to accelerate cooling of the formed product after blow molding, an additional cooling circuit can also be introduced into the mold, via which the wall temperature is lowered again after the actual blow molding process (but before the mold is opened). Alternating heating and cooling phases or other temperature profiles are also possible.

The blow molding process or other process steps can take place entirely or partially in a dried atmosphere or in an inert gas atmosphere. Here, a dried atmosphere is to be understood as, for example, air or nitrogen with a greatly reduced moisture proportion. Nitrogen, helium or argon can be used, for example, as inert gases. Argon is particularly advantageous if corrosive or reactive materials are used which would change chemically on contact with oxygen in the air or moisture in the air.

The method can be carried out in such a way that one or more of the process steps is/are carried out entirely or partially in this dried atmosphere or inert gas atmosphere. For this purpose, parts of the blow molding apparatus can be operated, for example, under a hood or in a closed environment.

After inflation, the formed product solidifies in the mold, it also being possible for complete solidification to take place only after removal. Subsequently, the mold is opened entirely or partially (for example, by separating the mold halves or opening slides), and the formed product which is then called a green product is removed. This removal can take place, for example, by a robot with a suitable gripping arm or else manually.

It can be necessary and appropriate at this point to post-treat the green product manually or by machine. For example, burrs or other excess material can be removed, or the hollow body of the green product can be opened at defined locations. In this way, for example, a closed, elongate hollow body can be processed to form a pipe.

As the green product is still relatively soft and capable of being processed at this stage, further components can also be combined with the green product in this phase of the method. These components can be further components which are manufactured by blow molding. Combination with other components which are manufactured by different processes is also possible (for example, with green products which are manufactured by metal injection molding). In this way, different pipes can also be joined together, for example, to form a T-piece, or premanufactured metal parts (for example, threaded rods etc.) can be integrated into the green product. This greatly increases the freedom during design of the metallic or ceramic products which can be manufactured according to the method which is described.

The connection can take place in different ways. Here, welding is to be mentioned, for example. This can take place, in particular, when two green products are to be combined and when a thermoplastic component is used in the process as binder. The two green products are heated and pressed together, for example, at their combining location, the binder being melted and the two green products being combined. Other combining technologies are also possible, however, for example a pressing technique or screwing.

Subsequently, the binder material is removed completely or partially from the green product (binder removal), the green product being converted into what is known as a brown product. The binder removal can take place in different ways which are described in principle in Arburg technische Information: Powder Injection Molding [Arburg technical information: powder injection molding]. Here, the binder is removed from the green product, for example, by catalysis and/or solution and/or thermal decomposition. As a rule, this process step takes from several hours to several days.

The binder removal can be assisted by a suitable oven temperature and oven atmosphere which favors the progress of the chemical reactions. An inert gas atmosphere, a reactive atmosphere, a dried atmosphere or a vacuum is also possible during binder removal.

In addition or as an alternative, the binder removal can also take place with the assistance of solvents. Here, the type of solvent has to be adapted to the binder. Here, the green product can be dipped, for example, into a solvent bath or rinsed with solvents.

Furthermore, in addition or as an alternative, decomposition of the binder material can also take place by suitable catalysts, for example acids. For this purpose, for example, the green product can be dipped into a fluid which contains a catalyst or rinsed with said fluid. Here, the binder material is decomposed catalytically into decomposition products which can be removed more readily and which in turn can be removed thermally (outgassing, removal by heat) and/or by solvent treatment and/or by further catalytic decomposition.

As a result of the binder removal, the green product is converted into what is known as a brown product. Here, a volumetric reduction occurs as a consequence of the removal of the mass proportion of the binder material, and the component shrinks.

Nevertheless, it has proven advantageous if, during binder removal, a first form gage is introduced entirely or partially into the green product. A form gage is understood here to be a rigid body, for example a shaped body from stainless steel, which represents a defined minimum dimension which is to be maintained. The shrinking process can then take place only as far as this minimum size, for example, in the case of a form gage which is introduced into the interior of the shaped body. Form gages of this type are known, for example, from the publication JP 03024203 A. As an alternative, depending on the design of the shaped part, a form gage can also be fit onto the green product.

If the green product is, for example, a pipe with a cylindrical inner space, the form gage can be designed as a cylindrical round rod with a diameter which corresponds to the internal diameter of the green product. A combination of form gages which are introduced and form gages which are fit on from the outside is also possible.

The form gage has the effect that the internal diameter of the green product does not change, or changes only insubstantially, during binder removal. At the same time, the form gage can also be used as a transfer apparatus for a large number of components, for example for transferring the brown products from binder removal to sintering. The form gage can be of rigid or else flexible design, the latter serving, for example, to compensate for or to prevent the stresses in the material which occur during binder removal.

After binder removal, the brown product is subjected to a temperature treatment step (sintering). Here, the ceramic and/or metallic grains of the mixture are melted at the grain surface and combined with one another to form a solid material.

The temperatures during sintering have to be adapted to the material (that is to say, the metal and/or the ceramic). The sintering temperatures typically lie at approximately from ⅔ to ¾ of the absolute melting temperature (see, for example, Römpp Lexikon Chemie, 10. Auflage [Römpp Lexicon of Chemistry, 10th Edition], Thieme Verlag, Stuttgart, 1999, keyword “sintering”). Temperature ramps have also proven favorable, it being possible for the temperature ramps to be interrupted in turn by holding phases at defined temperatures. In order to prevent oxidation of the materials during sintering, the sintering can take place in a dried atmosphere or in an inert gas atmosphere (for example, nitrogen or argon). Sintering under a vacuum is also possible.

Once again, a volumetric reduction regularly occurs during sintering. Said volumetric reduction can also take place anisotropically, that is to say can occur in different spatial directions with different severity. Overall, the reduction between the green product and the finished component typically lies at approximately 30%. In order to reduce the reduction overall, a second form gage (for example, the same form gage as during binder removal (see above)) can also be used during sintering of the brown products, which second form gage is pushed entirely or partially into the hollow space of the brown product or is fit entirely or partially onto the brown product.

In contrast to the known injection molding process, the described method permits the manufacture of complex hollow bodies of different embodiments from metallic and/or ceramic materials with the use of a blow molding process. It is also therefore possible, for example, to manufacture metallic or ceramic pipes having threads or an expanding bellows. Furthermore, a particular advantage lies in the fact that heterogeneously composed hollow bodies can also be manufactured.

Here, it has proven particularly advantageous if the method is used in such a way that a macroscopically varying composition of the tube is brought about as early as the production of the tube (for example by extruding).

A macroscopically varying composition is to be understood as a variation in the composition on a scale of more than two to three (or 10, 20, 50 or 100) mean grain diameters of the metallic or ceramic powder (typically approximately 0.01 mm). A further possibility for a macroscopically varying composition is a composition which is composed of different layers if cut perpendicular to the plane of elongation of the composition, e.g. perpendicular to the wall of a tube to be formed. The thickness of these layers can be quite varying and there can be more than two different layers within the composition. These layers of the macroscopically varying composition can have thicknesses as thin as 10 μm or 100-200 μm. A typical thickness would be 0.5 to 1 mm.

The described blow molding process therefore differs advantageously from the known processes for manufacturing metallic or ceramic hollow bodies, such as metal injection molding or ceramic injection molding. In methods of this type, a variation in the composition of the green products is only possible with very great difficulty. In order to achieve a locally varying composition of the green products, complicated multiple component molds would have to be used as a rule which are so complicated and expensive that the process would be uneconomical. The geometries which can be achieved are also greatly restricted.

In the described method, in contrast, a variation of this type in the composition of the tube is possible without problems, for example, with the use of modern coextrusion heads (COEX heads). Here, a starting mixture with a temporally and/or locally varying composition can be fed to the extruded tube.

This macroscopically varying composition of the tube can take place in different embodiments and for different purposes. In one possible embodiment, the binder proportion in the tube can vary.

This can take place, for example, for the purpose of avoiding or of reducing stresses or tears in the workpiece at particularly curved sections. For this purpose, for example, a higher binder proportion can be added to the tube during extruding or injection molding in sections which are transformed by the blow molding into sections of more pronounced curvature than in sections which are transformed by the blow molding into sections of less pronounced curvature. Sections of the tube which are inflated to a greater extent during blow molding than other sections can also be provided with a higher binder proportion, in order to reduce stresses at these locations. Furthermore, the modeling accuracy during inflation can be increased at locations with particularly fine structures if an increased binder proportion is added to the tube at said locations.

Furthermore, as an alternative or in addition, the tube can be designed in such a way that it has sequential sections with a different metal powder and/or ceramic powder proportion. Here, sequential is to be understood as a variation which occurs along a tube axis (for example, an axis of symmetry in a cylindrical tube) or in the direction of extrusion. During forming of the tube, different materials can then be used temporally one after another. Hollow bodies or pipes, in particular, which have alternating ceramic and metallic segments can be manufactured in this way. This can be used, for example, to adapt regions within a pipe which are loaded differently in an optimum manner to said loading by a suitable selection of the materials. For instance, regions with high thermal loading can be made from metal for optimum heat dissipation, whereas regions with pronounced chemical loading can be manufactured from ceramic materials. The sequential combination of different metal types or different ceramic materials is also possible.

Furthermore, as an alternative or in addition, it is also possible to achieve a radial variation in the composition of the tube and therefore of the finished component. Here, radial is to be understood as a variation perpendicularly with respect to the tube axis. This can also be realized only with difficulty, or not at all in practice, with the known methods (for example, CIM, MIM). In contrast, in the described method, this radial variation can be brought about, for example, by use of the abovementioned COEX extrusion heads.

One important example which can be realized by the described method is the manufacture of multiple-layer pipes. For example, the interior of pipes can be manufactured from a layer of chemical-resistant material (for example, chromium), whereas the exterior of the pipe is manufactured from a less expensive material (for example, steel) which ensures the mechanical strength of the pipe. Furthermore, more than two layers are also possible, with the result that, for example, special, corrosive materials can also be used which are protected on the inside and the outside by one or more passivation layers. Combinations of a plurality of layers of ceramic and metallic material are also possible. Furthermore, a process is also possible, in which individual layers are generated which consist only of binder material. A process of this type can serve, for example, to reduce stresses in the material which occur, in particular, at greatly inflated locations.

In addition to the described method in its various embodiments, a composition of the mixture for carrying out the blow molding method for metallic and/or ceramic products is also the subject matter of the invention.

A mixture which can be blow molded for manufacturing ceramic and/or metallic hollow bodies is therefore proposed, which has the following components:
a) a metal powder and/or ceramic powder, and
b) a binder material,
c) a silyl compound (silicon/hydrogen compound) as adhesion promoter.

Here, the component b) of the mixture is to be selected in such a way that it has a viscosity of at least 1000 Pa s at the Vicat softening temperature.

In many cases, the combination of the metallic and/or ceramic powder with the binder material can cause problems in the event of plastification. In particular, it can occur that the binder material adheres only insufficiently to the ceramic and/or metallic particles. This can lead, for example, to an inhomogeneity in the finished workpiece or to the formation of tears. For this reason, it is appropriate to add an adhesion promoter to the mixture. Said adhesion promoter should be used in a concentration of not more than 1.5 percent by weight. Here silyl compounds (that is to say, silicon/hydrogen compounds) have proven suitable, such as silanols.

Here, the metal powder can also be present as a constituent part of a compound. It is particularly advantageous if the volumetric proportion of the component a) is at least 60% of the overall volume. For example, metals in entirely or partially oxidized form can be used, and furthermore metal aggregates and/or organometallic compounds.

It is particularly advantageous to use at least one of the elements aluminum, iron, nickel, titanium, molybdenum or chromium in elementary form or in the form of a compound.

It is particularly advantageous if the mean grain size (diameter) of the component a) (that is to say of the ceramic and/or metallic powder) is not more than 20 micrometers. This ensures easy processability of the mixture and a high strength and low porosity of the finished workpiece after sintering.

The selection of the component b) (binder material) also has to be adapted to the requirements of the described process. This binder material can be, for example, thermoplastics (also, for example, silicon/hydrogen compounds). Mixtures of different binder materials can also be used.

Here, substantially three binder concepts are known from the technology of the PIM process. The first binder concept is based on the use of polyolefin/wax mixtures. This type of binder can be removed later from the green product during binder removal by slow heating. A second binder concept is based on partially soluble binder systems, in which at least part of the binder can be removed from the green product by use of solvents. The water soluble polyvinyl alcohols are to be mentioned here as an example. A third known binder concept is based on binder systems which can be decomposed catalytically. A very important example here are binder systems which are based on polyoxymethylene (POM) which is converted during binder removal by strong acids into formaldehyde which gases out of the green product. In addition, however, further binder concepts are conceivable, such as binders which can be removed from the green product during binder removal by a complete thermal decomposition.

As shown above in the description of method step b), the mixture should be set to a viscosity of over 1000 Pa s before forming of the tube. For this to be possible at all, the component b) should have a viscosity of 1000 Pa s at the Vicat softening temperature according to DIN 53460. This ensures that the mixture can be processed without problems to form a continuous tube. Here, it has proven favorable, in particular, if the component b) even has a viscosity of at least 3000 Pa s at the Vicat softening temperature. Even binder materials with viscosities of more than 10,000 Pa s or even of 40,000 Pa s and more are frequently used.

### BRIEF DESCRIPTION OF THE DRAWINGS

In the following text, the invention will be explained in greater detail using exemplary embodiments which are shown, inter alia, diagrammatically in the figures. However, the invention is not restricted to the examples. Here, identical designations in the individual figures denote identical or functionally identical elements or elements which correspond to one another with regard to their functions. In detail:

FIG. 1 shows a diagrammatic illustration of the method sequence;

FIG. 2 shows a sectional illustration of a simple tube before and after inflation in a blow mold having a cylindrical indentation;

FIG. 3 shows a sectional illustration of a tube which is composed radially of a binder layer, a binder/metal layer and a second binder layer, in a blow mold having a cylindrical indentation;

FIG. 4 shows a sectional illustration of a tube which is composed radially of a binder/ceramic layer and a binder/metal layer, in a blow mold having a cylindrical indentation;

FIG. 5 shows a sectional illustration of a tube which is composed sequentially of binder/metal mixtures having different binder contents, in a blow mold having a cylindrical indentation;

FIG. 6 shows a sectional illustration of a tube which is composed of different layers of locally different thickness, in a blow mold having a cylindrical indentation; and

FIG. 7 shows a blow mold having a heating circuit and a cooling circuit.

### DETAILED DESCRIPTION OF PREFERRED EMBODIMENTS

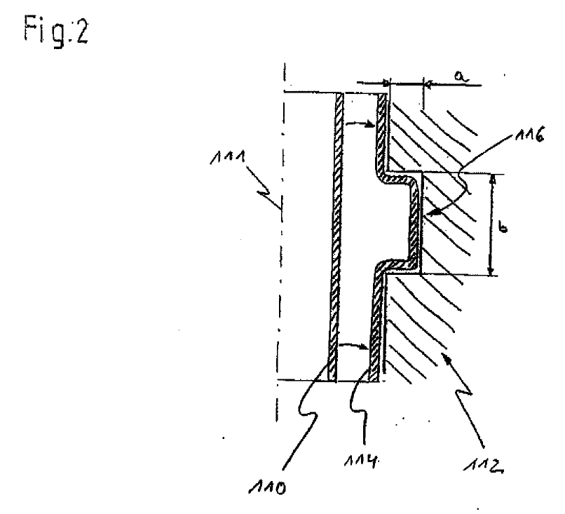

FIG. 2 shows diagrammatically how an extruded tube 110 having a round cross section and an axis 111 of symmetry changes in a blow mold 112 during inflation: the outer side of the tube assumes approximately the shape of the cavity of the blow mold and changes into the formed product 114.

Here, the cylindrical indentation 116 in the mold is particularly critical. Here, a segment of the tube is inflated from an original length b to the length 2a+b (a denoting the depth of the cylindrical indentation) and is therefore stretched to a particularly pronounced extent, to be precise by a stretching ratio (2a+b)/b. The maximum possible stretching ratio is also denoted as the inflation ratio.

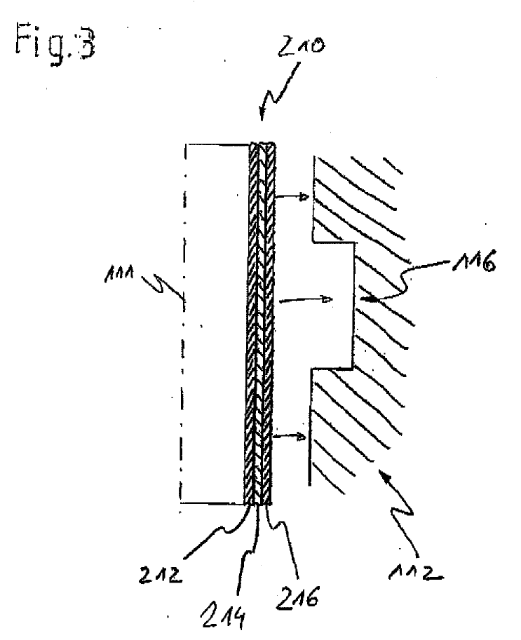

FIG. 3 diagrammatically shows one preferred exemplary embodiment of a blow molding process of a metallic hollow body. The same blow mold as in FIG. 2 is used. The tube 210 is extended in such a way that it is composed of three cylindrical layers 212, 214, 216 (of approximately identical thickness in this case). In this example, the layers 212 and 216 are layers which consist of pure binder material, for example a thermoplastic. In contrast, the layer 214 which is embedded in between consists of a mixture of the same binder material with iron powder.

This multiple-layer composition of the tube increases the inflation ratio during blow molding to a pronounced extent. This can be seen positively, in particular, at the location of the cylindrical indentation 116 in the blow mold 112. The layers 212 and 216 which consist of pure binder material increase the flowability of the tube wall to a pronounced extent during inflation and, as a result, reduce the formation of tears and stresses in the region of the cylindrical indentation 116.

Moreover, the layer 214 is encapsulated by the two layers 212 and 216. This has a plurality of advantages. Firstly, the layer 214 is very abrasive as a result of the addition of the metal powder and would lead rapidly to wear of the blow mold 112 without encapsulation, on account of the high hardness of the metal powder. Furthermore, the encapsulation protects the layer 214 against environmental influences.

Instead of two binder layers 212 and 216, it is also possible to use only one binder layer, for example only the binder layer 216 in order to improve the flow behavior.

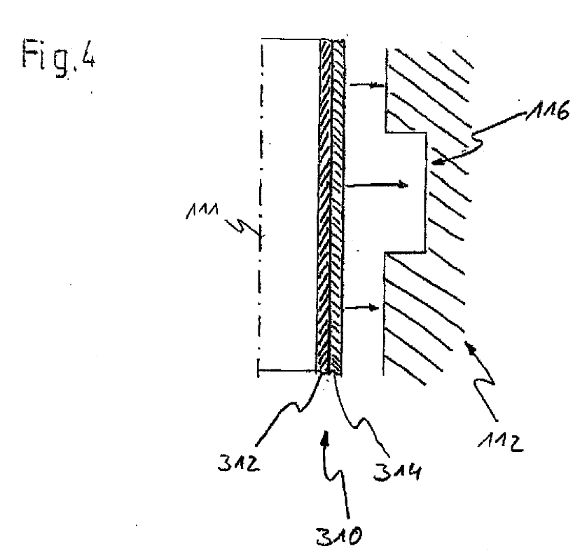

FIG. 4 shows the manufacture of a hollow body which has an inner wall made from ceramic material and an outer wall made from metal. To this end, a cylindrical tube 310 which is composed of an inner layer 312 and an outer layer 314 is manufactured by coextrusion. The inner layer 312 consists of a mixture of a binder material and a ceramic powder. The outer layer 314 consists of a mixture of the same binder material and aluminum powder.

By blow molding in the blow mold 112 and subsequent binder removal and sintering, hollow bodies can therefore be manufactured (for example, pipes for chemical reaction technology or the automotive industry). Said pipes are coated on the inside with ceramic and therefore have a high resistance, for example, with respect to aggressive chemicals. On the outside, the pipes consist of aluminum which ensures a low weight with a simultaneous high dimensional stability.

In addition, in an analogous manner to the method which is described in FIG. 3, the tube 310 can also be provided with one or more layers which are composed of pure binder material, in order to improve the flowability and the inflation ratio.

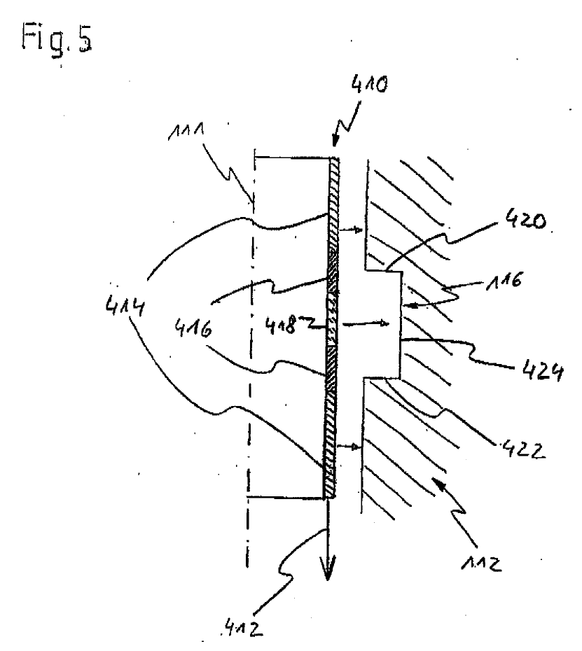

FIG. 5 shows a manufacturing process of a metallic hollow body by blow molding, in which a tube 410 with a sequentially varying composition is used.

The blow mold 112 which has already been described in the preceding figures and has a cylindrical indentation 116 is used once again. In the extrusion direction 412, the tube has sections 414, 416 and 418 which differ in each case in terms of the binder proportion in the starting mixture. Here, the sections 416 have the highest binder proportion, and the sections 414 have the lowest binder proportion.

The sections are selected in such a way that, during inflation, the sections 416 with the highest binder proportion come to rest on the flanks 420 and 422 of the cylindrical indentation 116 of the blow mold 112, and the section 418 with the medium binder proportion comes to rest on the end side 424 of the cylindrical indentation 116. In this way, stresses in the wall of the hollow body at locations of particularly high curvature and at locations which are stretched to a particularly pronounced extent are avoided by the increased binder proportion. At the same time, satisfactory modeling accuracy is ensured during inflation, as the tube 410 overall (that is to say, without an additional intermediate layer, as in FIG. 3, for example) can bear directly against the wall of the mold 112.

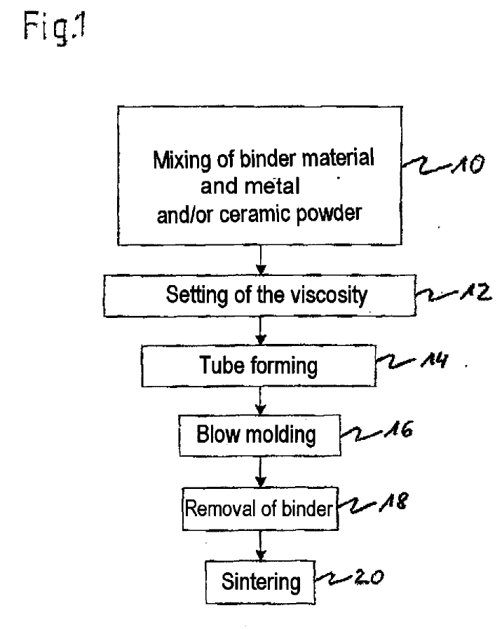

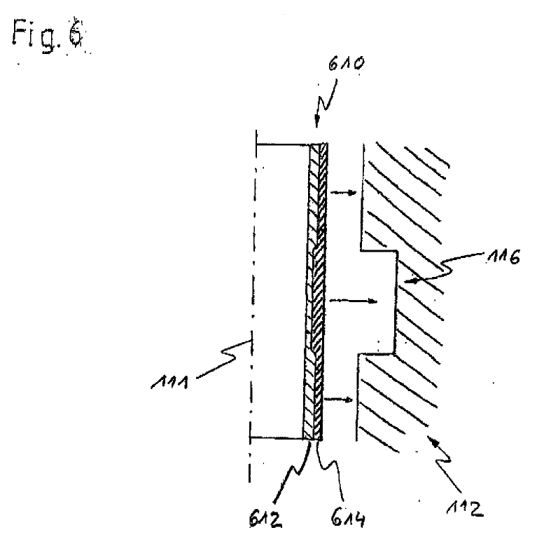

In addition to the possibility (demonstrated in FIGS. 1 to 3) of the radial (layer-like) variation of the composition of the tube and the possibility (shown in FIGS. 4 and 5) of a sequential variation of the composition of the tube, a combination of these two variation types is also possible. This is shown in FIG. 6.

A cylindrical tube 610 having a uniform thickness is produced once again by a coextrusion process. The tube is inflated in a blow mold 112 having a cylindrical indentation 116. The tube 610 is composed of two different layers 612 and 614. Both layers contain a metal powder proportion and a binder proportion, the binder proportion in the layer 614 being greater than in the layer 612.

In the region of the cylindrical indentation 116, the thickness of the layer 614 is increased and the thickness of the layer 612 is reduced correspondingly, with the result that the thickness of the tube 610 is not changed overall. This ensures that the tube has a higher binder proportion overall in the region of the cylindrical indentation 116. This contributes to stresses in the formed product being avoided.

In this exemplary embodiment, the overall thickness of the tube 610 is also not changed in the region of the cylindrical indentation 116. In an alternative embodiment of the method (not shown), the thickness of the tube can also be changed (for example, increased) in the region of the indentation 116, in order to make a higher inflation ratio overall possible in this region.

In principle, the same extruders and molds which are also known from the industrial blow molding process can be used for the described methods for manufacturing metallic and/or ceramic hollow bodies. Nevertheless, some improvements are possible which optimize the blow molding process of ceramic and/or metallic hollow bodies with regard to the particular properties of the ceramic/metal/binder mixtures.

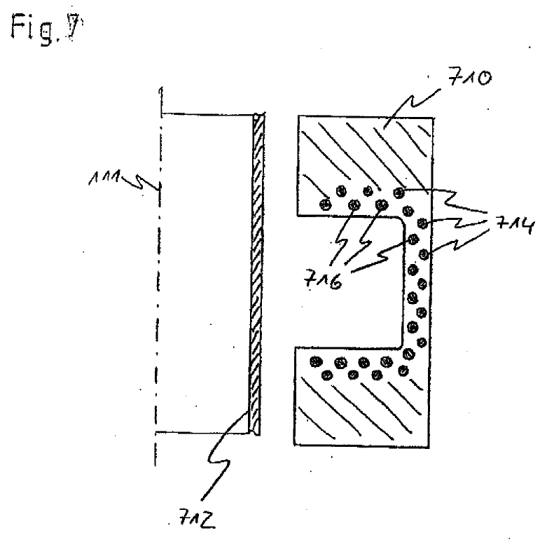

A blow mold 710 (that is to say, a mold half of said blow mold) which is particularly suitable for blow molding a tube 712 which is manufactured from a binder/metal mixture is therefore shown in FIG. 7. Said mold has a heating circuit 716 in addition to a cooling circuit 714 (which is customary in blow molds). As a result of this heating circuit 716, the mold can be set to an increased temperature between 60° C. and 120° C. during the blow molding process. This can be necessary in the case of various mixtures having a high crystallization temperature, as otherwise the melt of the tube 712 would already solidify during inflation in some circumstances, before it reaches the wall of the mold 710. Incomplete filling of the mold nests would be the consequence. This effect is avoided by the use of the heating circuit 716.

After blow molding, the heating is switched off and the mold is cooled via the cooling circuit 714 to a temperature of 10° C. This ensures rapid cooling of the formed product and therefore a shortening of the cycle times, as the formed product can be demolded from the mold only after complete solidification.

In the following text, five compositions are described of typical mixtures for carrying out the blow molding method for manufacturing metallic and/or ceramic hollow bodies.

### FIRST EXAMPLE

A first mixture is particularly suitable for manufacturing metal pipes by means of the described blow molding process. The mixture has 65% by volume carbonyl iron with an alloy of 2% nickel having a mean grain size of from 4 to 8 micrometers.

A proportion of 35% by volume HDPE (high density polyethylene) is added to the mixture as binder material, which has a mass flow rate (MFR according to the standard EN ISO 1133) of 2.2 g/10 minutes at a test temperature of 190° C. and a test weight of 21.6 kg. This corresponds to a viscosity of approximately 48,000 Pa s.

The mixture is mixed in a Z-kneader and homogenized and subsequently granulated. After blow molding, the formed products have their binder removed thermally at a temperature of 290° C. and are subsequently sintered in a nitrogen atmosphere at 1120° C.

### SECOND EXAMPLE

A second mixture is likewise suitable for manufacturing metallic hollow bodies. The mixture has 68% by volume carbonyl iron with the same nickel alloy and having the same grain size as in the first example. However, 32% by volume of polyacetal is added to said mixture as binder material. The polyacetal is intended to have a volumetric flow rate (MVR according to the standard EN ISO 1133) of 1.3 ml/10 minutes at a test temperature of 190° C. and a test weight of 2.16 kg. This corresponds to a viscosity of approximately 8300 Pa s.

### THIRD EXAMPLE

A third mixture is likewise suitable for manufacturing metallic hollow bodies. The composition is identical in principle with the composition in the first example. Here, however, the metal powder is silanized before mixing in of the binder material by addition of 0.5% by weight silanol. This addition improves the compatibility of the filler with the binder material and therefore increases the homogeneity of the mixture.

### FOURTH EXAMPLE

A fourth mixture is particularly suitable for manufacturing ceramic pipes by means of the described blow molding process. In principle, the mixture has an identical composition to example 1, the 65% by volume carbonyl iron powder being replaced by 65% by volume aluminum oxide ceramic powder having a mean grain size of from 0.4 to 0.6 micrometers. The sintering temperature lies at 1680° C.

### FIFTH EXAMPLE

A fifth mixture is likewise suitable for manufacturing ceramic hollow bodies. In principle, the mixture has an identical composition to example 2, the 68% by volume carbonyl iron powder being replaced by 68% by volume aluminum oxide ceramic powder having a mean grain size of from 0.4 to 0.6 micrometers. The sintering temperature again lies at 1680° C.

While the invention has been illustrated and described as embodied in hollow bodies, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method for manufacturing a first hollow body which has at least one metallic and/or ceramic component, having the following steps:
a) a binder material is mixed with a ceramic and/or metallic powder;
b) the viscosity of the mixture is set to a value of at least 1000 Pa s;
c) the mixture which is produced is shaped into a tube by means of one or a plurality of nozzles;
d) the tube is shaped to form a second hollow body (green product) by means of a blow molding process;
e) the green product is converted into a third hollow body (brown product) with removal of the binder material (binder removal);
f) the brown product is converted into the first hollow body by a temperature treatment step (sintering), and g) step c) being carried out in such a way that the tube which is produced has a macroscopically varying composition.

2. The method as claimed in claim 1, wherein the tube which is produced in step c) has a higher binder proportion in sections which are transformed by the blow molding into sections of more pronounced curvature than in sections which are transformed by the blow molding into sections of less pronounced curvature.

3. The method as claimed in claim 1, wherein the tube which is produced in step c) has sequential sections with different metal powder and/or ceramic powder proportions.

4. The method as claimed in claim 1, wherein the tube which is produced in step c) is composed radially of layers with different metal powder and/or ceramic powder proportions and/or binder proportions.

5. The method as claimed in claim 4, wherein during blow molding in step d), a blow mold is used with a temperature of at least 60° C. and at most 120° C.

6. The method as claimed in claim 1, wherein at least one of the method steps takes place entirely or partially in a dried atmosphere or an inert gas atmosphere.

7. The method as claimed in claim 1, wherein in step e) during removal of the binder, a first form gage is introduced entirely or partially into the green product or is fit onto the green product.

8. The method as claimed in claim 1, wherein in step f) during sintering, a second form gage is introduced entirely or partially into the brown product or is fit onto the brown product.

9. The method as claimed in claim 1, wherein before step e) and/or step f) are/is carried out, at least one further component is combined with the green product or brown product.

10. A mixture which can be blow molded for manufacturing ceramic and/or metallic hollow bodies as claimed in claim 1 having the following components:
a) a metal powder and/or ceramic powder;
b) a binder material; and
c) a silyl compound (silicon/hydrogen compound) as adhesion promoter; the component b) having a viscosity of at least 1000 Pa s at the Vicat softening temperature.
